(19) United States
(12) Patent Application Publication
(10) Pub. No.: US 2017/0026591 A1
(43) Pub. Date: Jan. 26, 2017

(54) IMAGE SENSOR

(71) Applicant: CANON KABUSHIKI KAISHA, Tokyo (JP)

(72) Inventor: Osamu Yuki, Tokyo (JP)

(21) Appl. No.: 15/211,077

(22) Filed: Jul. 15, 2016

(30) Foreign Application Priority Data
Jul. 21, 2015 (JP) 2015-143599

(51) Int. Cl. H04N 5/355; H04N 5/232; H04N 5/3745

(52) U.S. Cl. CPC H04N 5/3559; H04N 5/37452; H04N 5/23245

(57) ABSTRACT

In an image sensor, pixels each including a photoelectric converter PD converting an amount of incident light into a charge, charge storage including at least one of capacitors storing the charges, and an amplifier Tr6 amplifying a voltage according to the charges stored in the capacitor and outputs the voltage are disposed. The image sensor includes: comparing units 3 to 5 comparing the output voltage from the amplifier Tr6 to a predetermined threshold voltage; a memory unit 1 storing comparison results from the comparing units 3 to 5; switchers Tr9 to Tr14 deciding the capacitor connected to the photoelectric converter PD and the amplifier Tr6 among the capacitors included in the charge storage based on the comparison results stored in the memory unit 1; and a signal line transmitting a signal Φ_{sc} for controlling whether the switchers Tr9 to Tr14 decide the capacitor to the switchers Tr9 to Tr14.

### BACKGROUND OF THE INVENTION

Field of the Invention

The present invention relates to an image sensor.

Description of the Related Art

Image sensors such as CMOS sensors used in imaging apparatuses photoelectrically convert captured subject images in units of pixels to perform conversion into video signals according to the intensity of light and perform image signal processing. Recent image sensors are required to support a plurality of dynamic ranges such as in multi-use of still image photographing and moving image photographing. As such an image sensor, there is an image sensor including a switch unit that converts a dynamic range in units of pixels (Japanese Patent No. 4921581).

In the image sensor disclosed in Japanese Patent No. 4921581, when the number of supported dynamic ranges increases, the number of signal lines for controlling the switch unit is considered to increase or a load of a control process is considered to increase. For example, the increase in the number of signal lines can lead to a reduction in a light reception area of pixels. Japanese Patent No. 4921581 does not describe this problem.

An object of the present invention is to provide an image sensor that is, for example, advantageous in switching of a dynamic range.

According to the present invention, in an image sensor, pixels each including a photoelectric converter that converts an amount of incident light into a charge, a charge storage that includes at least one of capacitors storing the charges, and an amplifier that amplifies a voltage according to the charges stored in the capacitor and outputs the voltage are disposed. The image sensor includes: a comparing unit configured to compare the output voltage from the amplifier to a predetermined threshold voltage; a memory unit configured to store a comparison result from the comparing unit; a switcher configured to decide the capacitor connected to the photoelectric converter and the amplifier among the capacitors included in the charge storage based on the comparison result stored in the memory unit; and a signal line configured to transmit a signal for controlling whether the switcher decides the capacitor to the switcher.

Further features of the present invention will become apparent from the following description of exemplary embodiments with reference to the attached drawings.

### BRIEF DESCRIPTION OF THE DRAWINGS

FIG. 1 is a diagram illustrating a circuit configuration of a pixel included in an image sensor according to a first embodiment.

FIG. 2 is a table illustrating each Tr state in each mode of the image sensor according to the first embodiment.

FIG. 3 is a diagram illustrating potentials at connection points in a circuit of pixels according to the first embodiment.

FIG. 4 is a flowchart illustrating switching of a dynamic range.

FIG. 5 is a diagram illustrating identification information of sensitivity, selected capacitors corresponding to the identification information, and magnifications of photoelectric conversion signals.

FIG. 6 is a diagram illustrating information regarding an output signal.

FIG. 7 is a diagram illustrating the image sensor configured to include the pixels according to the first embodiment.

FIG. 8 is a timing chart illustrating operation timings of components included in the circuit of the pixels according to the first embodiment.

FIG. 9 is a diagram illustrating the image sensor including a plurality of pixels according to the first embodiment.

FIG. 10 is a diagram illustrating a circuit configuration of pixels included in an image sensor according to a second embodiment.

FIG. 11 is a timing chart illustrating operation timings of components included in the circuit of the pixels according to the second embodiment.

FIG. 12 is a circuit diagram illustrating the circuit of the pixels according to the first embodiment to which a noise separation circuit is added.

FIG. 13 is a diagram illustrating operation timings of components in a circuit related to a noise separation method.

FIG. 14A is a diagram illustrating a luminance distribution read from the image sensor according to the first and second embodiments.

FIG. 14B is a diagram illustrating a luminance distribution of an original image according to the first and second embodiments.

FIG. 14C is a table illustrating magnifications necessary when the luminance distribution read from the image sensor according to the first and second embodiments is demodulated to a luminance distribution of the original image.

FIG. 15A is a diagram illustrating a luminance distribution obtained by imaging light reflected from an object within a dynamic range using a normal image sensor.

FIG. 15B is a diagram illustrating a luminance distribution obtained by imaging light with the image sensor according to the invention.

FIG. 16 is a diagram illustrating a light reception configuration of a backside irradiation type image sensor.

### DESCRIPTION OF THE EMBODIMENTS

Hereinafter, embodiments of the present invention will be described with reference to the drawings and the like.

### First Embodiment

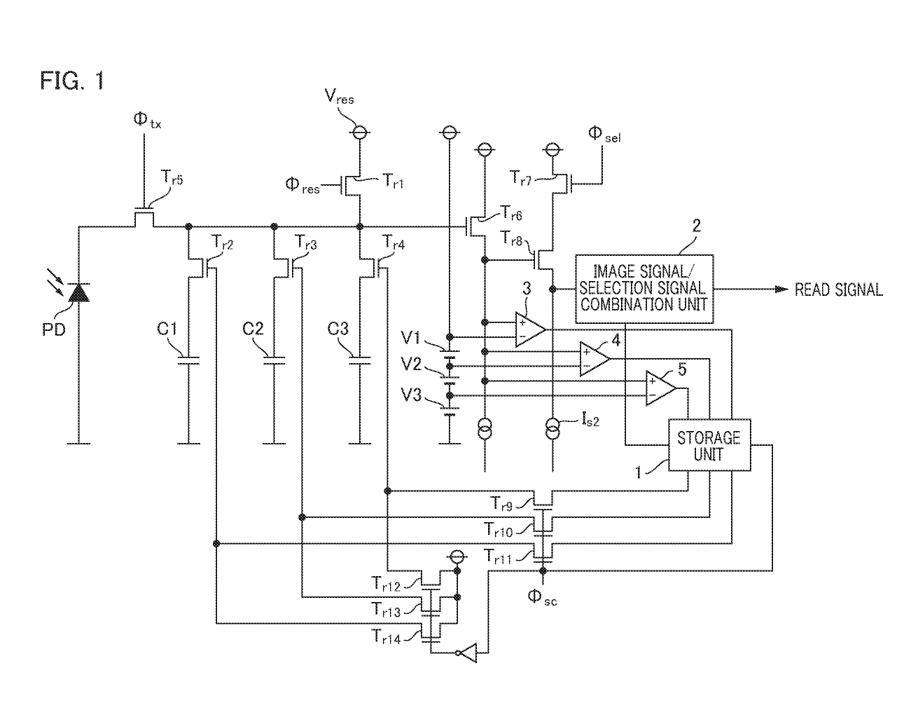

FIG. 1 is a diagram illustrating a circuit configuration of a pixel included in an image sensor according to a first embodiment of the present invention. The pixel includes a photodiode (photoelectric converter) PD, a charge storage including storage capacitors C1 to C3, MOS transistors Tr1 to Tr11, a memory unit 1, an image signal/selection signal combination unit 2, and voltage comparators (comparing units) 3 to 5. The PD converts the amount of light incident on the pixel into charges. The storage capacitors C1 to C3 are storage capacitors for switching a dynamic range (sensitivity) and are each disposed in parallel to a floating diffusion capacitor C_{fd} (not illustrated) provided in a gate of a source follower Tr6 (amplifier). The floating diffusion capacitor C_{fd} that stores charges converted by the PD is set to have capacitance at which an output voltage V_{fd} of Tr6 increases even if the amount of light incident on the PD is small. Tr2 to Tr4 which are changeover switches are connected to the storage capacitors C1 to C3.

Tr1 (reset unit) is a reset MOS transistor that discharges (sweeps) charges stored in the storage capacitors C1, C2, and C3 and the floating diffusion capacitor C_{fd}. After the reset, charges generated by the PD are stored in a parasitic capacitor C_{pd}. The charges are transmitted to the storage capacitors C1, C2, and C3 and the floating diffusion capacitor C_{fd} when Tr5 (transmission switch) is turned on. Tr6 functions as a source follower of a voltage generated when optical signal charges generated through the photoelectric conversion of the PD are transmitted to the storage capacitors C1, C2, and C3 and the floating diffusion capacitor C_{fd} via Tr5. The voltage V_{fd} source-followed by Tr6 is expressed as the parasitic capacitor C_{pd} of the PD/(a sum of the capacitance of C_{fd} and at least one capacitance of the storage capacitors C1 to C3). Voltage comparators 3, 4, and 5 are provided on the rear stage of Tr6. Predetermined threshold voltages V1, V2, and V3 are input to one ends of inputs of the comparators and an output voltage V_{fd} of Tr6 is input to the other ends of the comparators. Accordingly, the output voltage V_{fd} is compared to one of the threshold voltages V1 to V3.

The switching of the dynamic range according to the present invention has two operation modes, a sample mode and a comparison mode. Each mode is selected with a high/low level of a mode switching signal Φ_{sc}. In the sample mode, Tr9 to Tr11 are turned off, Tr12 to Tr14 are turned on, and Tr2 to Tr4 are all turned on by setting Φ_{sc} to the low level. Accordingly, the storage capacitors C1 to C3 and the floating diffusion capacitor C_{fd} are connected with an added value (where maximum storage capacitance corresponds to low sensitivity and high luminance). By turning off Tr5 and turning on Tr1 in this state, the charges stored in the storage capacitors C1 to C3 and the floating diffusion capacitor C_{fd} are discharged. Next, charges generated by exposing the PD are stored in the parasitic capacitor C_{pd} of the PD. The charges are transmitted to the storage capacitors C1 to C3 and the floating diffusion capacitor C_{fd} when Tr5 is turned on. The transmitted optical signal charges are output as a voltage V_{fd} expressed in Formula (1) from Tr6.

$$[ Math . 1 ]$$

$${V}_{fd} = \frac{{V}_{photo} \times {C}_{pd}}{( {C}_{fd} + C 1 + C 2 + C 3 )} \qquad ( 1 )$$

Here, Vₚₕₒₜₒ is a voltage generated by the charges generated by the PD, and C1 to C3 are capacitances of the storage capacitors C1 to C3. V_{fd} is input to one ends of the comparators 3 to 5 and is compared to one of the threshold voltages V1 to V3 to determine at which threshold level the voltage V_{fd} is in imaging of low sensitivity.

When the mode switching signal Φ_{sc} is set to be high and the mode is switched to the comparison mode, Tr9 to Tr11 are turned on, Tr12 to Tr14 are turned off, Tr2 to Tr4 are controlled to be turned on or off based on a comparison result stored in the memory unit 1, and a storage capacitor to be connected is decided. For example, a case in which the comparison result in the sample mode is V_{fd}<V3 will be described. In this case, one of a case in which only Tr4 is turned on (C3 is connected), a case in which Tr4 and Tr3 are turned on (C3 and C2 are connected), and a case in which Tr2 to Tr4 are all turned on (C1 to C3 are connected) is selected.

The case in which only Tr4 is turned on will be considered. If V_{fd} is less than V3, there is no change in that the storage capacitor to be connected is C3. If V_{fd} is less than V2, Tr3 is turned on and the storage capacitor C2 is further connected. If V_{fd} is less than V1, Tr2 is turned on and the storage capacitor C1 is further connected.

If Tr4 and Tr3 are turned on and V_{fd} is equal to or greater than V2 and less than V1, Tr2 is turned on and the storage capacitor C1 is further connected. If Tr2 to Tr4 are all turned on, no storage capacitor is further added or connected irrespective of the magnitude of V_{fd}.

The states in which the Tr2 to Tr4 are turned on and off are stored as identification information of sensitivity in the memory unit 1. When Tr7 is turned on in accordance with a signal Φₛₑₗ, the output voltage V_{fd} from Tr6 is superimposed with the comparison result (identification information of the sensitivity) stored in the memory unit 1 via Tr8 by the image signal/selection signal combination unit 2 and is output to the outside.

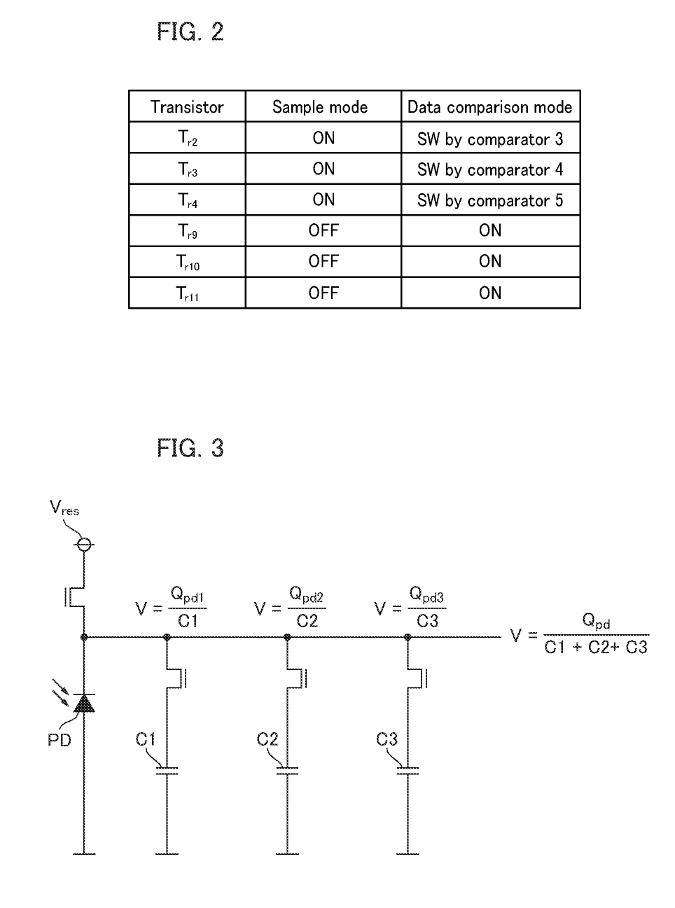

In FIG. 2, a state of each Tr in each mode is summarized. In the sample mode, Tr9 to Tr11 are turned off, Tr12 to Tr14 are turned on, and Tr2 to Tr4 are all turned on. In the comparison mode, Tr9 to Tr11 are turned on, Tr12 to Tr14 are turned off, and Tr2 to Tr4 are turned on or off based on the comparison result in the comparators 3 to 5 to decide the storage capacitors to be connected. In the embodiment, C1 to C3 are sequentially selected for addition, but C1, C2, and C3 may be configured to be selected individually.

When the floating diffusion capacitor C_{fd} is sufficiently small, a potential at each connection point is set as in FIG. 3. Charges Q_{pd} generated by the PD are distributed as Q_{pd1}, Q_{pd2}, and Q_{pd3} to C1 to C3. In the sample mode, involvement of C1 is large at a 3-digit level. Therefore, even if C1 to C3 are all connected, switching of a dynamic range can be determined by minutely adjusting the potentials of V1, V2, and V3. For example, when a capacitance ratio of C1:C2:C3 is set to 1,000,000:1,000:1, switching can be performed with a width of about 120 dB.

Trial calculation of V_{fd} under connection conditions of C1, C2, and C3 when I_{d} is a photoelectric conversion current generated by the PD in the configuration of FIG. 3 will be described below. A current ratio of high luminance, intermediate luminance, and low luminance is set to high luminance current:intermediate luminance current:low luminance current=1,000,000:1,000:1. A capacitance ratio of C1 to C3 has been described above. In the sample mode in which C1 to C3 are all connected, a relation among I_{d}, a storage time t, and the voltage V_{fd} is set as in Formula (2).

$$[ Math . 2 ]$$

$${V}_{fd} = \frac{( \frac{{I}_{d} \times t}{{C}_{pd}} ) \times {C}_{pd}}{( {C}_{fd} + C 1 + C 2 + C 3 )} \qquad ( 2 )$$

If only C3 is selected and connected in the comparison mode, a relation among the photoelectric conversion current I_{d}, the time t, and the voltage V_{fd} is set as in Formula (3).

$$[ Math . 3 ]$$

$${V}_{fd} = \frac{( \frac{{I}_{d} \times t}{{C}_{pd}} ) \times {C}_{pd}}{( {C}_{fd} + C 3 )} \qquad ( 3 )$$

Similarly, when C3 and C2 are selected and connected in the comparison mode, a relation among the photoelectric conversion current I_{d}, the time t, and the voltage V_{fd} is set as in Formula (4).

$$[ Math . 4 ]$$

$${V}_{fd} = \frac{( \frac{{I}_{d} \times t}{{C}_{pd}} ) \times {C}_{pd}}{( {C}_{fd} + C 2 + C 3 )} \qquad ( 4 )$$

Similarly, when C3 to C1 are selected and connected in the comparison mode, relations among the photoelectric conversion current I_{d}, the time t, and the voltage V_{fd} are set as in Formula (5).

$$[ Math . 5 ]$$

$${V}_{fd} = \frac{( \frac{{I}_{d} \times t}{{C}_{pd}} ) \times {C}_{pd}}{( {C}_{fd} + C 1 + C 2 + C 3 )} \qquad ( 5 )$$

At the current ratio of high luminance current:intermediate luminance current:low luminance current=1,000,000:1,000:1, selection capacitance at the time of the high luminance current (the time of low sensitivity):selection capacitance at the time of the intermediate luminance current:selection capacitance at the time of the low luminance current (the time of high sensitivity)=1001001:1001:1 is set. Accordingly, output voltage characteristics are all substantially the same in the three cases. That is, the voltage can be output according to each selection sensitivity without saturation of the output voltages at the time of the high luminance, the time of the intermediate luminance, or the time of the low luminance.

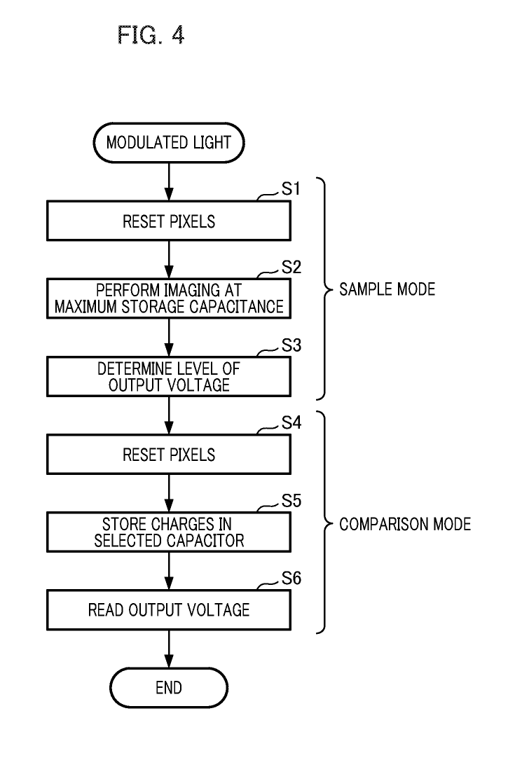

FIG. 4 illustrates the flow of the switching of the dynamic range. As described above, there are two modes, the sample mode and the comparison mode, in the switching control according to the present invention. The sample mode operates in the flow of S1 to S3 and the comparison mode operates in S4 to S6. First, as described above, the storage capacitors C1 to C3 and the floating diffusion capacitor C_{fd} are connected by setting the mode switching signal Φ_{sc} to the low level and turning on Tr2 to Tr4. Subsequently, in S1, Tr1 resets the storage capacitors C1 to C3 and the floating diffusion capacitor C_{fd}. After the resetting, imaging is performed at the maximum storage capacitance in S2 (high luminance and low sensitivity). The charges generated by the PD are stored in the parasitic capacitor C_{pd} of the PD. When Tr5 is turned on, the charges are transmitted to the storage capacitors C1 to C3 and the floating diffusion capacitor C_{fd} of the gate of Tr6. In S3, the voltage V_{fd} amplified by Tr6 and output is compared to one of the threshold potentials V1 to V3 to determine at which threshold level the voltage V_{fd} is in the imaging at the time of low sensitivity. If V_{fd} is greater than V1, there is a possibility of the output voltage being saturated depending on luminance. Therefore, for example, the capacitance of C1 is set to be greater for handling.

When the mode switching signal Φ_{sc} is set to a high level to turn on Tr9 to Tr11 and turn off Tr12 to Tr14, the mode is switched to the comparison mode. In this mode, Tr2 to Tr4 are controlled to be turn on or off based on the comparison results of the comparators 3 to 5. In S4, Tr1 resets the storage capacitors C1 to C3 and the floating diffusion capacitor C_{fd}. After the resetting, the voltage V_{fd} output in the state in which the storage capacitors C1 to C3 are not connected is input to one ends of the inputs of the comparators 3 to 5 and is compared to one of the threshold voltages V1 to V3. The comparison result is stored in the memory unit 1. In S5, imaging is performed by the storage capacitor selected based on the comparison result stored in the memory unit 1. When Tr5 is turned on, the charges generated by the PD and stored in the parasitic capacitor C_{pd} of the PD are transmitted to the capacitor selected among the storage capacitors C1 to C3 and the floating diffusion capacitor C_{fd} of the gate of Tr6. In S6, Tr7 is turned on, and the voltage V_{fd} amplified by Tr6 is superimposed with the comparison result (identification information of sensitivity) stored in the memory unit 1 via Tr8 by the image signal/selection signal combination unit 2 and is output to the outside (reading of the output voltage).

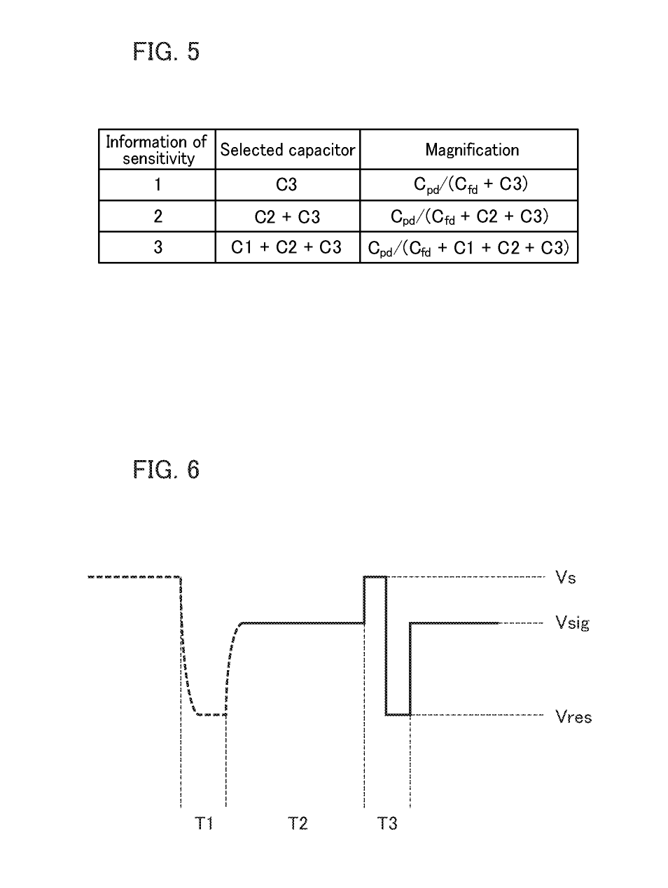

FIG. 5 illustrates the identification information of the sensitivity, the selected capacitors corresponding to the identification information, and magnifications of photoelectric conversion signals. Information regarding the signals superimposed and output by the image signal/selection signal combination unit 2 is illustrated in FIG. 6. In FIG. 6, a signal during a period T1 indicates a state in which the PD is reset. This signal is indicated by a dotted line since the signal is not directly output to the outside. During a period T2, an output level of an optical signal after the sensitivity selection is set. After this signal is output during the period T2, information regarding three sensitivity switching timings (selected capacitor selection switching timings) is output at signal levels of Vₛ and Vᵣₑₛ in binary digits during a period T3. For example, a signal of “10” during the period T3 indicates that C2+C3 at a second threshold position is selected.

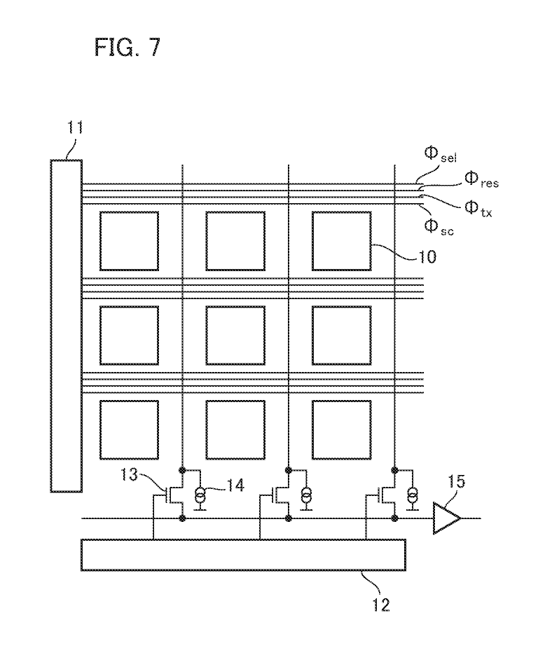

FIG. 7 is a diagram illustrating the image sensor configured to include the pixels illustrated in FIG. 1. For simplicity, a configuration of 3×3 pixels in an entire circuit is illustrated. In the image sensor, a method of performing reading by scanning each row is adopted. The image sensor includes a vertical scanning circuit 11 for row scanning, a horizontal scanning circuit 12 for column scanning, pixels 10, column selection MOS transistors 13, current loads 14, and an amplifier 15. The pixels 10 are the same as the pixels of the image sensor illustrated in FIG. 1. Φₜₓ, Φᵣₑₛ, and Φₛₑₗ from the vertical scanning circuit 11 are connected to signal lines with the same reference numerals illustrated in FIG. 1. To switch between the sample mode and the comparison mode, signal lines through which the mode switching signal Φ_{sc} passes as described above are directly connected to all of the pixels. For simplicity, only four signal lines are illustrated. An optical signal from each pixel is output to the amplifier 15 via the horizontal scanning circuit 12 (a horizontal shift register and a multiplexer (not illustrated)) and the column selection MOS transistor 13 along one signal output line to which the current load 14 is connected. The column selection MOS transistor 13 is a switch that operates with a signal from the horizontal scanning circuit 12 and selects a signal line in the column direction.

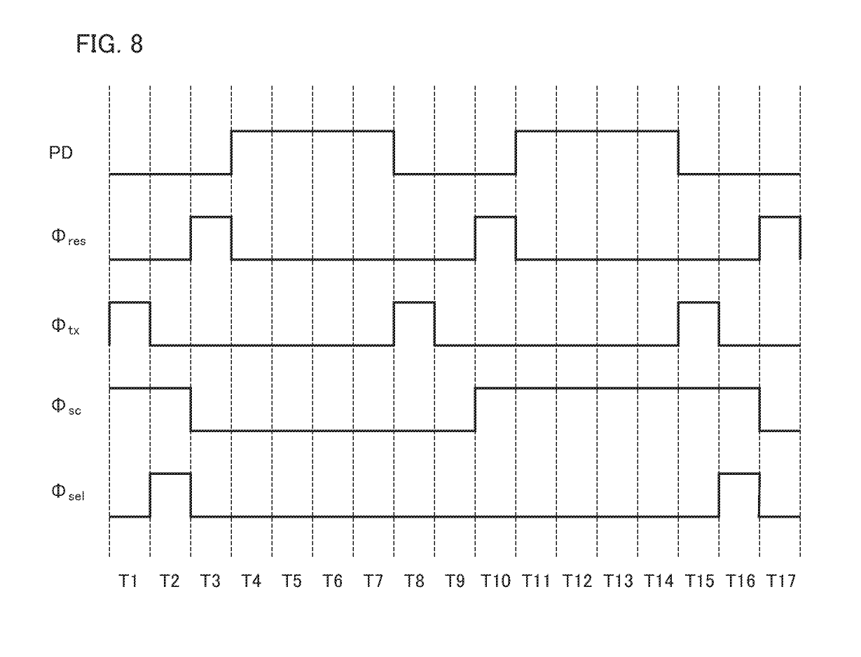

FIG. 8 is a timing chart illustrating operation timings of components included in the circuit of the pixels according to the embodiment. The sample mode is set during T3 to T9 and the comparison mode is set during T10 to T16. During T3, Φ_{sc} is turned off and the sample mode is set. Further, Φᵣₑₛ is turned on and the storage capacitors C1 to C3 and the floating diffusion capacitor C_{fd} are reset by Tr1. Exposure is collective exposure and is performed at the same timing for all the pixels of the image sensor as illustrated in FIG. 7. Accordingly, in the image sensor, temporal deviation of an image does not occur between the scanning lines. During optical charge storage periods T4 to T7, the transmission switch Tr5 is in an off state (Φₜₓ is at a low level) and optical charges generated during periods 14 to 17 are stored in the parasitic capacitor C_{pd}. Meanwhile, the optical charges are not transmitted to the storage capacitors C1, C2, and C3 or the floating diffusion capacitor C_{fd} formed in the gate of the source follower Tr6. When the storing of the PD ends, the charges stored in the parasitic capacitor C_{pd} are transmitted to the storage capacitors C1 to C3 and the floating diffusion capacitor C_{fd} of the gate of Tr6 by turning on Tr5 at the high level of the signal Φₜₓ collectively in all of the pixels during T8. Thereafter, the signal Φₜₓ is set to the low level collectively in all of the pixels during T9 and Tr5 is turned off.

Next, during T10, Φ_{sc} is turned on to set the comparative mode. Further, Φᵣₑₛ is turned on so that the storage capacitors C1 to C3 and the floating diffusion capacitor C_{fd} are reset by Tr1. During optical charge storage periods T11 to 114, the transmission switch Tr5 is in an off state and the optical charges generated during periods T11 to 114 are stored in the parasitic capacitor C_{pd}. Meanwhile, the optical charges are not transmitted to the selected capacitor among C1, C2, and C3 and the floating diffusion capacitor C_{fd} formed in the gate of the source follower Tr6. When the storing of the PD ends, the charges stored in the parasitic capacitor C_{pd} are transmitted to the storage capacitors C1 to C3 and the floating diffusion capacitor C_{fd} of the gate of Tr6 by turning on Tr5 at the high level of the signal Φₜₓ collectively in all of the pixels during T15. Subsequently, during T16, the signal Φₛₑₗ from the vertical scanning circuit 11 is set to the high level collectively in all of the pixels. Accordingly, Tr7 is turned on so that a circuit formed by a load current source Iₛ₂ and Tr8 enters an operation state. Simultaneously, the PD enters an exposure-enabled state of a subsequent frame by setting the signal Φₜₓ to the low level collectively in all of the pixels.

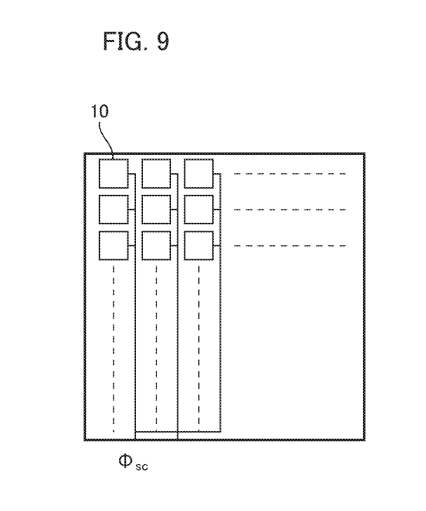

FIG. 9 is a diagram illustrating the image sensor including a plurality of pixels according to the first embodiment. Only one signal line required to transmit the signal Φ_{sc} for switching of the dynamic range is present for each pixel 10. The switching control can be performed merely by setting the level of Φ_{sc}. That is, it is not necessary to wire a signal line for each sensitivity and a load of the control process is not heavy.

According to the embodiment, as described above, it is possible to provide the image sensor that is advantageous in the switching of the dynamic range.

### Second Embodiment

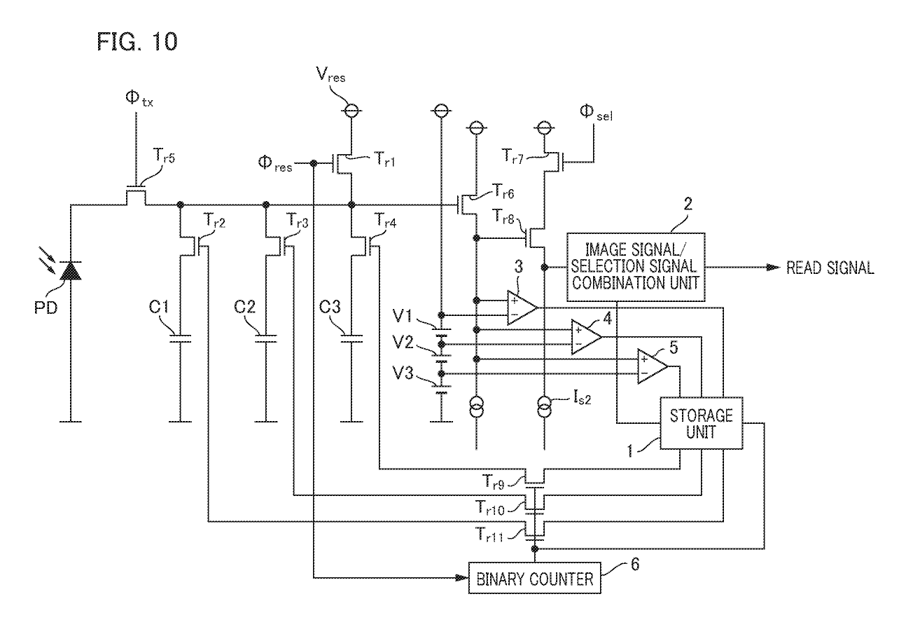

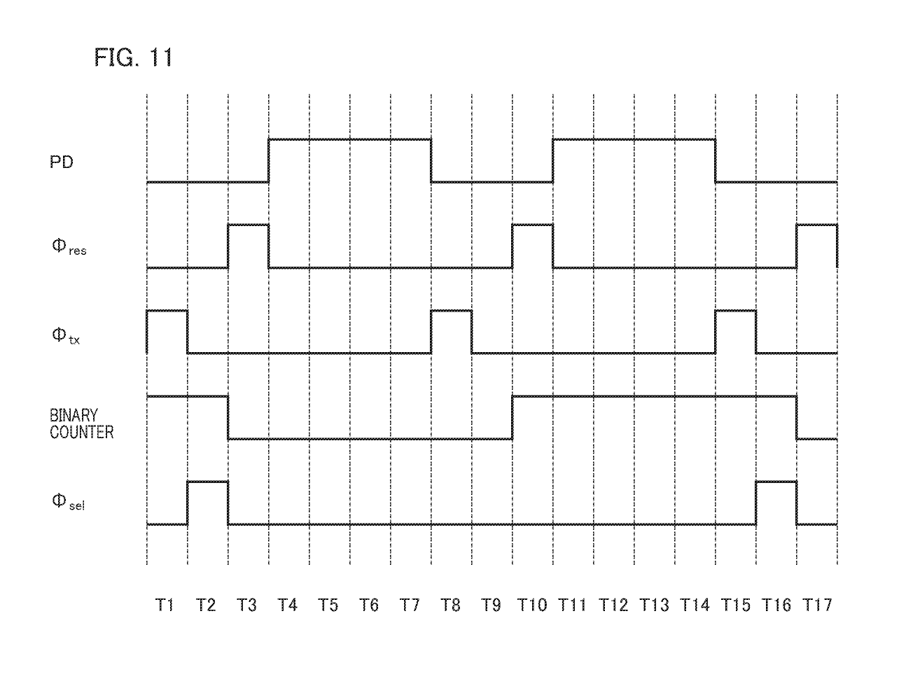

Next, an image sensor according to a second embodiment of the present invention will be described. FIG. 10 is a diagram illustrating a circuit configuration of pixels included in an image sensor according to the embodiment. Instead of the wiring used to input the mode switching signal Φ_{sc} from the outside of the pixel to the inside of the pixel, a binary counter 6 to which Φᵣₑₛ is input is disposed in the pixel according to the embodiment. Based on Φᵣₑₛ, the switching control is performed by the binary counter 6. That is, the pixels autonomously perform the switching control. Accordingly, it is possible to reduce the number of signal lines and the load of the control process compared to the first embodiment. FIG. 11 is a timing chart illustrating operation timings of components included in the circuit of the pixels according to the embodiment. In FIG. 11, the level of the binary counter becomes a low level during T3 in which Φᵣₑₛ rises, and then becomes a high level during a period T10 in which Φᵣₑₛ subsequently rises. The operation timings of Φ_{sc} and a binary counter 6 are the same as in FIG. 7 illustrating the operation timings according to the first embodiment. As described above, the image sensor according to the embodiment has the same advantages as that of the first embodiment.

(Noise Separation)

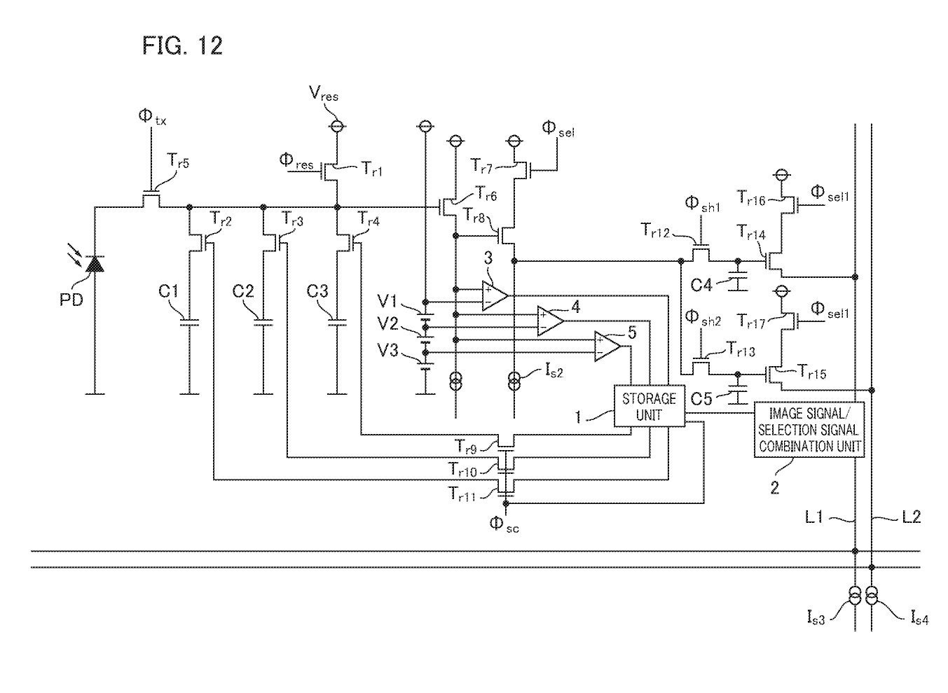

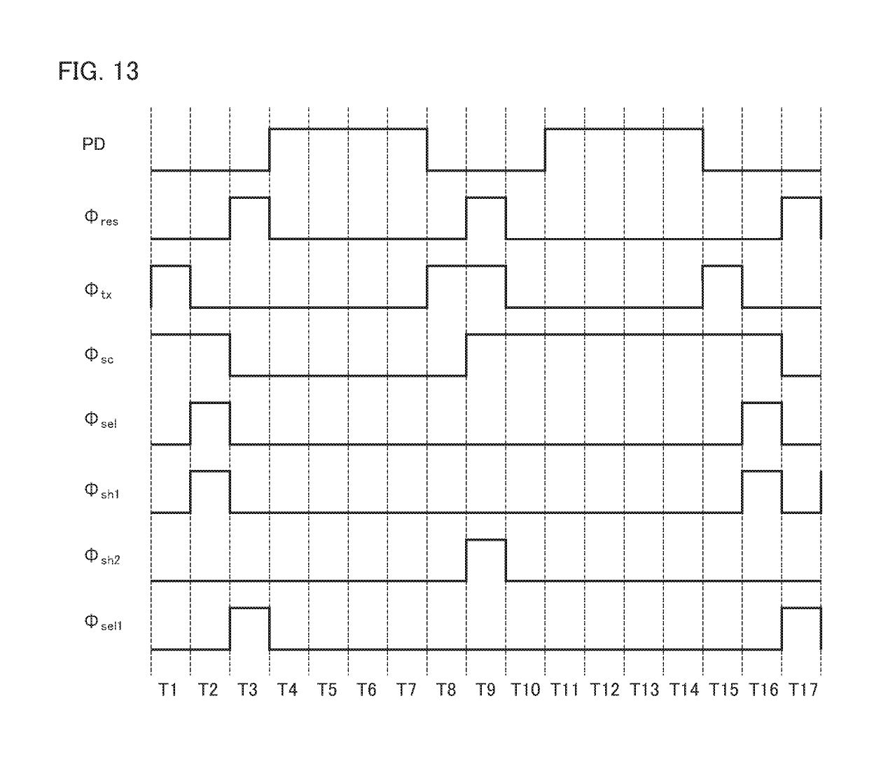

A noise separation method for the image sensor which can be applied to the first and second embodiments will be described. FIG. 12 is a circuit diagram illustrating the circuit of the pixels according to the first embodiment to which a noise separation circuit is added. The noise separation circuit includes transistors Tr12 to Tr17 and signal retention capacitors C4 and C5. FIG. 13 is a diagram illustrating operation timings of components in a circuit related to the noise separation method. The sample mode is set during periods T3 to T8 and the comparison mode is set during periods T9 to T16. In the comparison mode, Φₛₕ₂ is set to a high level at a switch timing T9 and a reset signal is transmitted to the signal retention capacitor C5 by turning on Tr13. This signal is generated in the sample mode by the PD, is a signal indicating the charges transmitted to the selected capacitor among C1, C2, and C3 and a floating diffusion capacitor C_{FD} of the gate of Tr6, and includes thermal noise, 1/f noise, and fixed pattern noise. During a period T10, Φₛₕ₂ is set to a low level and the transmission ends.

In imaging during the periods T11 to T14, charges generated by the PD are stored in the parasitic capacitor C_{pd}. When Tr5 (the transmission switch) is turned on during the period T15, the charges are transmitted to the selected capacitor among C1, C2, and C3 and the floating diffusion capacitor C_{fd} of the gate of Tr6. The transmitted charges are transmitted to the signal retention capacitor C4 via Tr8 by further setting a signal Φₛₕ₁ to a high level during the period T16 and turning on Tr12. The charges also include the foregoing noise. The signal Φₛₕ₁ is set to a low level during a period T17 and the transmission ends. Simultaneously, a source follower circuit formed by load current sources Iₛ₃ and Iₛ₄ enters an operation state when a signal Φₛₑₗₗ is set to a high level and Tr16 and Tr17 are turned on. Accordingly, an optical signal and a noise signal retained in the signal retention capacitors C4 and C5 are transmitted to a noise signal output line L2 and an optical signal output line L1 via Tr14 and Tr15. The transmitted signals are subjected to a subtraction process (for signal-noise) by a subtraction output amplifier (not illustrated) connected to the noise signal output line L2 and the optical signal output line L1, and thus alight data signal from which the thermal noise, the 1/f noise, and FPN are removed is output.

At this time, the identification information of the sensitivity binarized and stored in the memory unit 1 is superimposed on the optical signal output line L1 by the image signal/selection signal combination unit 2 and is output to the outside. Accordingly, even after a subtraction process is performed by the subtraction output amplifier (not illustrated) connected to the noise signal output line L2 and the optical signal output line L1, the identification information of the sensitivity is retained in the signal. The light data signal is corrected with the identification information for use.

(Demodulation)

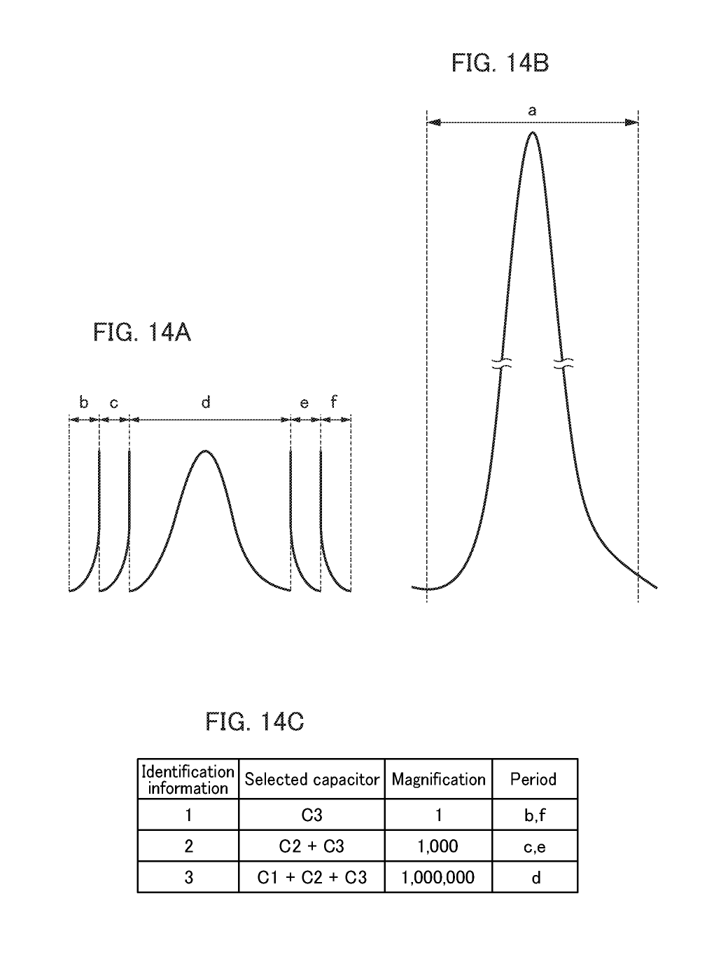

A method which can be applied to the first and second embodiments and which is a method of demodulating a signal (luminance distribution) read from the image sensor according to the present invention to a luminance distribution of an original image will be described with reference to FIGS. 14A to 14C. FIG. 14A is a diagram illustrating the read luminance distribution. FIG. 14B is a diagram illustrating the luminance distribution of the original image. Here, b to f illustrated in FIG. 14A indicate imaging periods of each sensitivity. FIG. 14C illustrates the identification information of the sensitivity during each period, the capacitor selected at that time, and magnification obtained based on the capacitor and necessary for demodulation. When signals are multiplied by magnification 1 during the periods b and f, signals are multiplied by magnification 1,000 during the periods c and e, a signal is multiplied by magnification 1,000,000 during the period d, and the signals are joined, demodulation can be performed as in FIG. 14B.

(Luminance Centroid Detection)

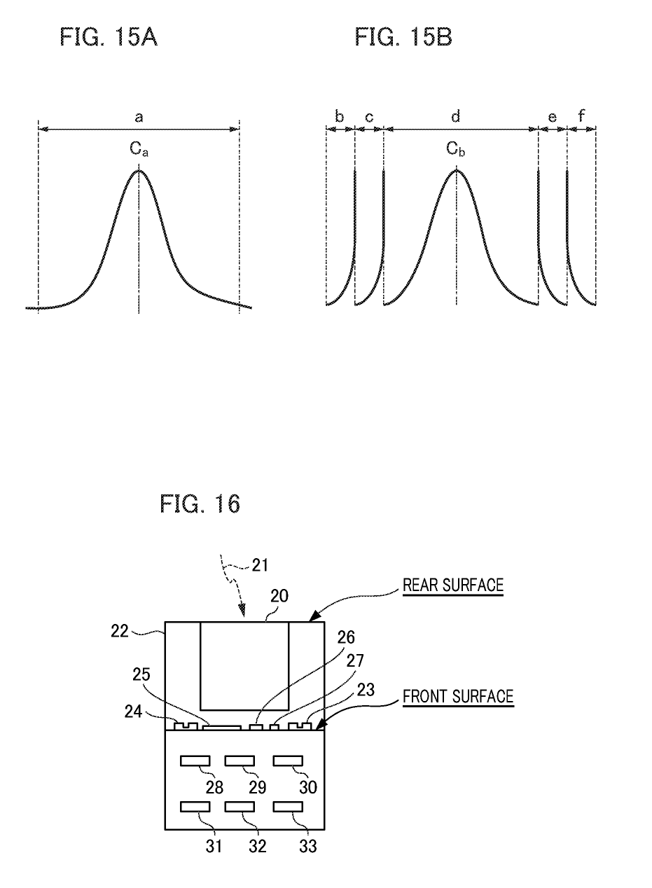

In image processing calculation, a luminance centroid of an image is necessary in many cases. In such cases, the luminance centroid is considered to be obtained by demodulating a read signal based on the identification information of the sensitivity in accordance with the above-described demodulation method. However, in the image sensor according to the present invention, the luminance centroid can be obtained without demodulation based on the identification information of the sensitivity. A specific method will be described with reference to FIGS. 15A and 15B. FIG. 15A illustrates a luminance distribution obtained by imaging light reflected from an object within a dynamic range using a normal image sensor. An image luminance centroid is denoted by Ca. FIG. 15B illustrates a luminance distribution when the same image is captured with the image sensor according to the present invention. The following 5 methods can be used when an image luminance centroid Cb is obtained from the luminance distribution. That is, (1) the image luminance centroid is obtained from a distribution of the period d. (2) The image luminance centroid is obtained from distributions of the periods c and e. (3) The image luminance centroid is obtained from distributions of the periods b and f. (4) The image luminance centroid is obtained from the distributions of the periods c, e, b, and f. (5) The image luminance centroid is obtained from the distributions of all the periods b to f. By selecting a method according to the shape or reflection characteristics of a target object or noise characteristics of the sensor, the luminance centroid more suitable for imaging conditions can be detected better than in a case in which the luminance centroid is obtained from an image captured by a normal image sensor.

A so-called backside irradiation type image sensor illustrated in FIG. 16 may be used as the image sensor according to the embodiments. The backside irradiation type image sensor has a structure in which incident light 21 is radiated from the rear surface of the image sensor. The image sensor includes a photodiode 20, a substrate 22, transistors 23 and 24, storage capacitors 25 to 27, and wirings 28 to 33. In this structure, many circuits or large capacitance can be elaborated in the pixels.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-143599 filed Jul. 21, 2015, which is hereby incorporated by reference herein in its entirety.

What is claimed is:

1. An image sensor in which pixels each including a photoelectric converter that converts an amount of incident light into a charge, a charge storage that includes at least one of capacitors storing the charges, and an amplifier that amplifies a voltage according to the charges stored in the capacitor and outputs the voltage are disposed, the image sensor comprising:
a comparing unit configured to compare the output voltage from the amplifier to a predetermined threshold voltage;
a memory unit configured to store a comparison result from the comparing unit;
a switcher configured to decide the capacitor connected to the photoelectric converter and the amplifier among the capacitors included in the charge storage based on the comparison result stored in the memory unit; and
a signal line configured to transmit a signal for controlling whether the switcher decides the capacitor to the switcher.

2. The image sensor according to claim 1,
wherein the signal line transmits the signal for controlling the decision of the switcher to the switcher after the comparing unit compares the voltage output by the amplifier to the threshold voltage according to the charges stored in all of the capacitors included in the charge storage.

3. The image sensor according to claim 1, further comprising:
a reset unit configured to reset the charge storage by sweeping all of the charges stored in the capacitors,
wherein the signal line transmits the signal to the switcher at a timing at which the reset unit resets the charge storage.

4. The image sensor according to claim 1, further comprising:
a demodulation unit configured to demodulate the charges converted by the photoelectric converter based on the voltage output by the amplifier according to the charges stored in the capacitor and the capacitor connected to the photoelectric converter and the amplifier and decided by the switcher among the capacitors included in the charge storage.
